(19) United States
(12) Patent Application Publication
(10) Pub. No.: US 2002/0163745 A1
(43) Pub. Date: Nov. 7, 2002

(54) Mirror surface angle adjusting mechanism

(75) Inventor: Masato Sakamoto, Aichi-ken (JP)

Correspondence Address: NIXON PEABODY, LLP, 8180 GREENSBORO DRIVE, SUITE 800, MCLEAN, VA, 22102, US

(73) Assignee: Kabushiki Kaisha Tokai-Rika-Denki-Seisakusho, Aichi-ken (JP)

(21) Appl. No.: 10/119,312

(22) Filed: Apr. 10, 2002

(30) Foreign Application Priority Data
Apr. 19, 2001 (JP) 2001-121008

(51) Int. Cl. G02B 7/182

(52) U.S. Cl. 359/872

(57) ABSTRACT

In a mirror surface angle adjusting mechanism, a hemispherical portion of a mirror holder inner is nipped between a predetermined number of ribs of case pivot and a support portion of support pivot with an urging force being acted. When the hemispherical portion is slid with respect to the ribs and the support portion, the mirror holder inner is slid such that a mirror surface angle of mirror held by the mirror holder inner is adjusted. Since the predetermined numbers of ribs have the same thickness, partial dent due to variation of the thickness does not occur at the predetermined number of ribs. Thus, a precision of spherical surface of pivot portion can be ensured. Further, clearances between the ribs serve as a lubricant pool, and the lubricant can be sufficiently filled into the pivot portion. Accordingly, a lack of the lubricant in the pivot portion can be prevented.

### BACKGROUND OF THE INVENTION

1. Field of the Invention

The present invention relates to a mirror surface angle adjusting mechanism which is mounted to a vehicle or the like and adjusts a mirror surface angle of a mirror for rearward vehicle vision.

2. Description of the Related Art

A vehicle or the like is provided with a mirror for rearward vehicle vision. A mirror surface angle adjusting mechanism 50 of the mirror includes, for example, as shown in FIGS. 3 through 5, a mirror holder inner 52 for holding a mirror for rearward vehicle vision (not shown). A hemispherical portion 54 which is formed in a substantially hemispherical shape is formed at the mirror holder inner 52. A circular opening 56 is formed at a center of the hemispherical portion 54.

A case pivot 58 is placed on the opposite side from the mirror side of the mirror holder inner 52. The case pivot 58 is formed of a case lower 58A and a case upper 58B. The case lower 58A is disposed at a side of the case pivot 58 facing the mirror holder inner 52. The case upper 58B is disposed at a side of the case pivot 58 opposite to the side thereof at which the mirror holder inner 52 is disposed. A convex portion 60 is formed on a whole periphery of the case lower 58A and a concave portion 62 is formed on a whole periphery of the case upper 58B. Due to the convex portion 60 fitting into the concave portion 62, the case lower 58A fits into the case upper 58B on their whole peripheries. As a result, waterproofing within the case pivot 58 is accomplished.

The case pivot 58 is provided with a pair of rods 64. The respective rods 64 insert into the case lower 58A. The mirror holder inner 52 is held by the tip ends of rods 64. The mirror holder inner 52 can tilt relative to the rods 64.

A pair of motors (not shown) is provided within the case pivot 58. Each motor has a motor main body and a motor shaft. A shown in FIG. 4, two pairs of motor main body receiving portions 66 are provided at a back surface side of the case lower 58A. Two pairs of motor bearing portions 68 are also provided at the back surface side of the case lower 58A. Each of the pairs of motor main body receiving portions 66 presses the motor main body, and each of the pairs of motor bearing portions 68 presses the motor shaft. In this way, the motors are fixed within the case pivot 58. The motor shafts are connected respectively to the rods 64. The rods 64 slide in their axial direction due to the driving of the motors.

A pivot portion 70 is formed at a front surface side of the case lower 58A. The pivot portion 70 is formed in a substantially hemispherical shape. A cylindrical pivot shaft 72 is formed upright at a center of the pivot portion 70. The hemispherical portion 54 of the mirror holder inner 52 is fitted into the pivot portion 70 with the pivot shaft 72 being inserted into the opening 56 of the mirror holder inner 52. A self-tapping screw 76 is screwed into the tip end of the pivot shaft 72 with a snap ring 74 being interposed therebetween.

A support pivot 78 is placed around the pivot shaft 72. The support pivot 78 has a substantially hemispherical support portion 80. The support portion 80 fits into the hemispherical portion 54 of the mirror holder inner 52. A cylindrical pivot cylinder 82 is provided at a center of the support portion 80. The pivot cylinder 82 surrounds the pivot shaft 72. An annular wall 82A is formed at the case pivot 58 side end portion of the pivot cylinder 82. The annular wall 82A fits into the pivot shaft 72.

A compression coil spring 84 is mounted between the snap ring 74 and the annular wall 82A of the pivot cylinder 82. The compression coil spring 84 applies an urging force to the support pivot 78. For this reason, the hemispherical portion 54 is nipped between the pivot portion 70 and the support portion 80 with the urging force of the compression coil spring 84 being acted. Thus, the mirror holder inner 52 is held between the case pivot 58 and the support pivot 78.

When the motors are driven and the rods 64 are slid in their axial direction, a tilt force is applied to the mirror holder inner 52. At this time, the hemispherical portion 54 is slid relative to the pivot portion 70 and the support portion 80 such that the mirror holder inner 52 is slid. In this way, a mirror surface angle of the mirror is adjusted.

However, in such mirror surface angle adjusting mechanism 50, in order to make the case pivot 58 compact, the motors, the convex portion 60 and the concave portion 62 are provided at a portion that the pivot portion 70 is formed. For this reason, the pair of motor main body receiving portions 66, the pair of motor bearing portions 68 and the convex portion 60 are formed at the back surface side of the pivot portion 70, i.e., at the portion opposing the pivot portion 70 on the back surface side of the case lower 58A, as shown in FIG. 4.

Because the pair of motor main body receiving portion 66, the pair of motor bearing portions 68 and the convex portion 60 are provided at the back surface side of the pivot portion 70, it is impossible to form a circular thinning portion 86 from the back surface side of the pivot portion 70. Therefore, it is difficult to make a thickness of the pivot portion 70 uniform. Specifically, since the pair of motor main body receiving portion 66 and the convex portion 60 are formed, the circular thinning portion 86 cannot be formed at the portion that the pair of motor main body receiving portion 66 and the convex portion 60 are formed. Thus, the thickness of the pivot portion 70 cannot be made uniform. Consequently, as shown in FIG. 4, the thickness of the pivot portion 70 is large at the portion that the pair of motor main body receiving portion 66 and the convex portion 60 are formed (i.e., a portion A shown in FIG. 5). Further, the thickness of the motor bearing portions 68 is decreased because the circular thinning portion 86 is formed. Thus, as shown in FIG. 4, strength of the motor bearing portions 68 may decrease.

As described above, since it is difficult to make the thickness of the pivot portion 70 uniform, a slight formation error such as a dent is apt to occur at the portion of the pivot portion 70 having a large thickness because of variation of thickness. Thus, there arises a problem in that it is difficult to ensure a precision of a spherical surface of the pivot portion 70. Thus, there arises a problem in that when the hemispherical portion 54 is slid relative to the pivot portion 70 and the support portion 80, when the mirror surface angle of the mirror is being adjusted, sliding noise is generated between the pivot portion 70 and the hemispherical portion 54.

Moreover, since the pivot portion 70 is formed in a substantially hemispherical shape, a lubricant such as grease or the like cannot be filled sufficiently into the pivot portion 70. Thus, the lubricant in the pivot portion 70 easily runs out. In a case in which the lubricant in the pivot portion 70 runs out, when the hemispherical portion 54 is slid relative to the pivot portion 70 and the support portion 80, when the mirror surface angle of the mirror is being adjusted, the hemispherical portion 54 catches against the pivot portion 70 such that swinging or sticking of the mirror may occur.

### SUMMARY OF THE INVENTION

In view of the above-mentioned, an object of the present invention is to provide a mirror surface angle adjusting mechanism which can ensure a precision of hemispherical surface of pivot portion and can prevent a lack of lubricant in the pivot portion.

In accordance with a first aspect of the present invention, there is provided a mirror surface angle adjusting mechanism comprising: a mirror retaining member having a hemispherical portion formed in a substantially hemispherical shape; a case member into which the hemispherical portion of the mirror retaining member is fitted and which has a plurality of ribs arranged in a circumferential direction relative to the hemispherical portion, the ribs including surfaces at a side at which the hemispherical portion fits, being substantially complementary to at least a part of the substantially hemispherical shape; and a lock means which nips the hemispherical portion of the mirror retaining member between the surfaces of the ribs and the lock means and which presses the hemispherical portion toward the ribs.

Further, the plurality of ribs each may have substantially the same thickness as one another. The lock means may comprise resiliently deformable member for pressing the hemispherical portion of the mirror retaining member so as to nip the hemispherical portion between the ribs and the lock means with an elastic force being acted. By tilting the retaining member, a mirror surface angle of the mirror can be adjusted.

In accordance with the first aspect of the present invention, the pivot portion of the case member has a predetermined number of ribs. The predetermined numbers of ribs are arranged in a circumferential direction relative to the hemispherical portion of the retaining member. Further, the surfaces of the predetermined number of ribs at the hemispherical portion side thereof are formed corresponding to a section of a hemispherical shape. The hemispherical portion is nipped between the predetermined number of ribs and the lock means with the elastic force being acted. Thus, the retaining member is held between the case member and the lock means.

Consequently, when the hemispherical portion is slid with respect to the predetermined number of ribs and the lock means, the retaining member is tilted such that the mirror surface angle of the mirror held by the retaining member is adjusted.

Since the predetermined numbers of ribs have substantially the same thickness, generation of partial dent caused by variation of the thickness of the ribs is significantly decreased. Accordingly, the precision of the spherical surface of the predetermined number of ribs which form the pivot portion can be ensured. When the hemispherical portion is slide with respect to the predetermined number of ribs and the lock means such that the mirror surface angle of the mirror is adjusted, it is possible to prevent generation of sliding noise between the predetermined number of ribs and the hemispherical portion.

Moreover, clearances between the ribs may act as a lubricant pool. Thus, the lubricant can be sufficiently filled into the pivot portion such that a lack of the lubricant in the pivot portion can be prevented. Accordingly, when the hemispherical portion is slid with respect to the predetermined number of ribs and the lock means such that the mirror surface angle of the mirror is adjusted, it is possible to prevent the hemispherical portion being caught by the predetermined number of ribs, swinging or sticking of the mirror.

### BRIEF DESCRIPTION OF THE DRAWINGS

FIG. 1 is a perspective view showing a case pivot of a mirror surface angle adjusting mechanism according to an embodiment of the present invention.

FIG. 2 is a cross-sectional view showing a main portion of the mirror surface angle adjusting mechanism according to the embodiment of the present invention.

FIG. 3 is a perspective view showing a case pivot of a conventional mirror surface angle adjusting mechanism.

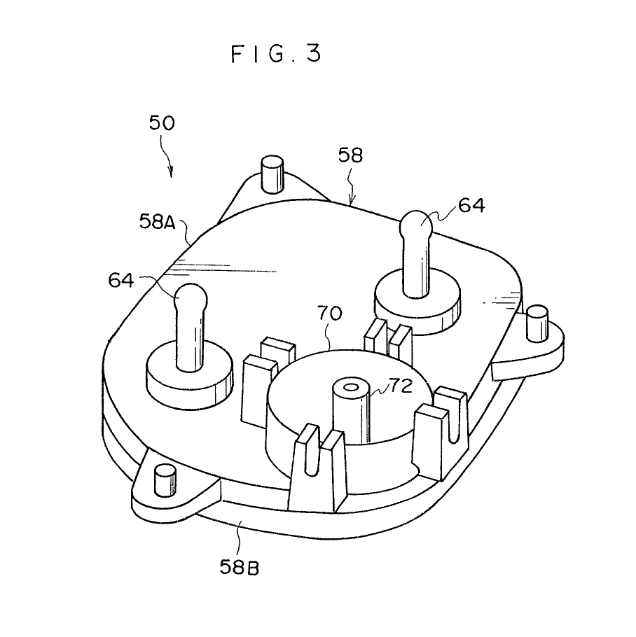

FIG. 4 is a back view showing a case lower of the conventional mirror surface angle adjusting mechanism.

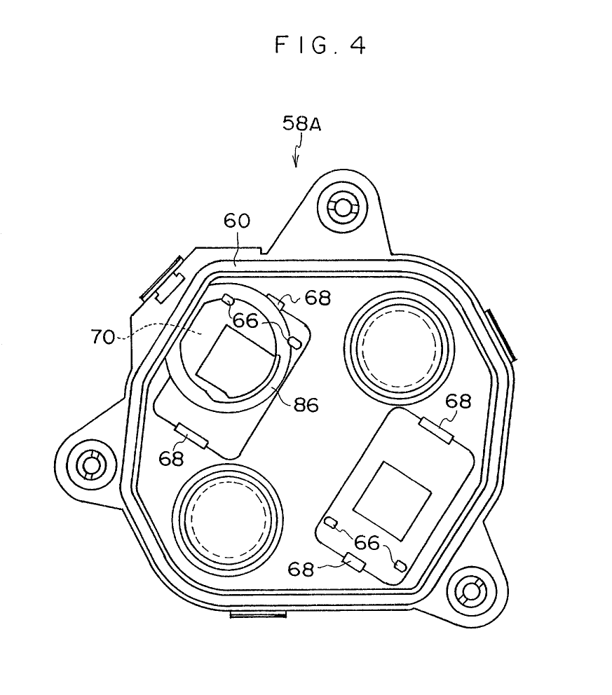

FIG. 5 is a cross-sectional view showing a main portion of the conventional mirror surface angle adjusting mechanism.

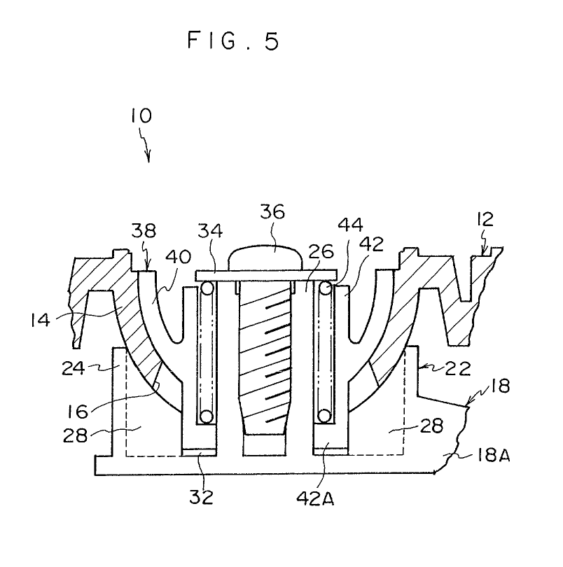

### DESCRIPTION OF THE PREFERRED EMBODIMENTS

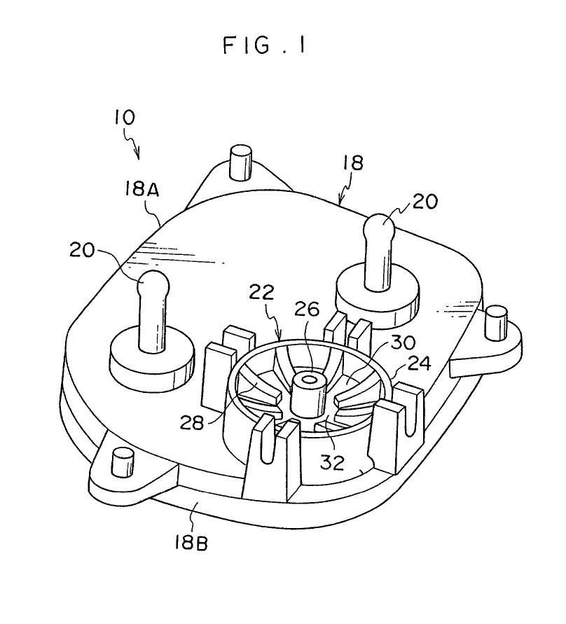

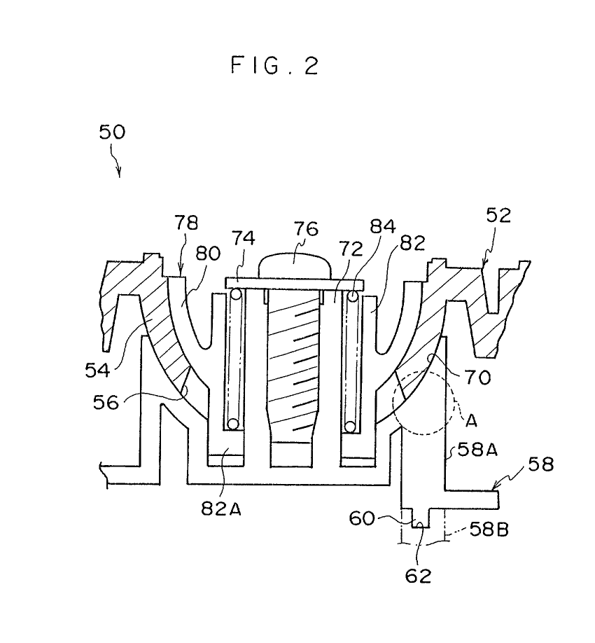

FIG. 1 shows a perspective view of a main portion of a mirror surface angle adjusting mechanism 10 according to an embodiment of the present invention. FIG. 2 is a cross-sectional view of the main portion of the mirror surface angle adjusting mechanism 10.

The mirror surface angle adjusting mechanism 10 relating to the present embodiment is applied to a vehicle door mirror device. The mirror surface angle adjusting mechanism 10 includes a mirror holder inner 12 serving as a retaining member. The mirror holder inner 12 holds a mirror for rearward vehicle vision (not shown). A hemispherical portion 14 formed in a substantially hemispherical shape is formed at the mirror holder inner 12. A circular opening 16 is formed at a center of the hemispherical portion 14.

A case pivot 18 serving as a case member is disposed at the opposite side from the mirror side of the mirror holder inner 12 (i.e., at the vehicle front side). The cave pivot 18 is connected via a frame, a retracting mechanism and a door mirror stay to a vehicle door (none of them are shown). The case pivot 18 is formed of a case lower 18A and a case upper 18B. The case lower 18A is disposed at a side of the case pivot 18 facing the mirror holder inner 12. The case upper 18B is disposed at a side of the case pivot 18 opposite to the side thereof at which the mirror holder inner 12 is disposed. The case lower 18A fits into the case upper 18B on their whole periphery such that waterproofing within the case pivot 18 is accomplished.

The case pivot 18 is provided with a pair of rods 20. The respective rods 20 insert into the case lower 18A. The mirror holder inner 12 abuts the tip ends of the rods 20 and is held thereby. The mirror holder inner 12 can tilt relative to the rods 20.

A pair of motors (not shown) is fixed within the case pivot 18. The motors are respectively connected to the rods 20. The rods 20 slide in their axial direction due to the driving of the motors.

A pivot portion 22 is formed at a front side of the case lower 18A. A cylindrical circumferential wall 24 is formed on an outer periphery of the pivot portion 22. A cylindrical pivot shaft 26 is formed upright at a center of the circumferential wall 24. A predetermined number (eight in the present embodiment) plate ribs 28 are formed within the circumferential wall 24. The predetermined number of ribs 28 is arranged, at substantially equal angular intervals therebetween, along a circumferential direction of the circumferential wall 24 (i.e., a circumferential direction of the hemispherical portion 14). The ribs 28 each have substantially the same thickness. A surface of each of the ribs 28 at the hemispherical portion 14 side is formed in a hemispherical shape. Thus, the hemispherical portion 14 is fitted into the predetermined number of ribs 28 with the pivot shaft 26 being inserted into the opening 16.

Lubricant pools 30 are formed between the ribs 28. A lubricant such as grease (not shown) is filled in the lubricant pools 30. The ribs 28 are formed integrally with the circumferential wall 24. A height of an edge of each of the ribs 28 at the circumferential wall 24 side is the same as that of the circumferential wall 24.

A cylindrical clearance 32 is formed between the pivot shaft 26 and the predetermined number of ribs 28. The lubricant is filled within the clearance 32. A self-tapping screw 36 is screwed into the tip end of the pivot shaft 26 with a snap ring 34 being interposed therebetween.

A support pivot 38 is disposed around the pivot shaft 26. The support pivot 38 has a support portion 40 formed in a substantially hemispherical shape. The support portion 40 is fitted into the hemispherical portion 14. A cylindrical pivot cylinder 42 is provided at a center of the support portion 40 so as to surround the pivot shaft 26. An annular wall 42A is formed at the case pivot 18 side end portion of the pivot cylinder 42. The annular wall 42A is fitted into the pivot shaft 26.

A compression coil spring 44 is mounted between the snap ring 34 and the annular wall 42A of the pivot cylinder 42. The compression coil spring 44 applies an urging force to the support pivot 38. Thus, the hemispherical portion 14 is nipped between the predetermined number of ribs 28 and the support portion 40 with the urging force (elastic force) of the compression coil spring 44 being acted. In this way, the mirror holder inner 12 is held between the case pivot 18 and the support pivot 38.

When the rods 20 are slid in their axial direction due to the driving of the motors, a tilt force is applied to the mirror holder inner 12. At this time, the hemispherical portion 14 is slid with respect to the predetermined number of ribs 28 and the support portion 40 such that the mirror holder inner 12 is tilted. In this way, the mirror surface angle of the mirror is adjusted.

Next, an operation of the present embodiment will be described. In the mirror surface angle adjusting mechanism 10 with the above-described structure, the pivot portion 22 of the case pivot 18 has a predetermined number of ribs 28. The predetermined number of ribs 28 is arranged along the circumferential direction relative to the hemispherical portion 14 of the mirror holder inner 12. The surfaces of the predetermined number of ribs 28 at the hemispherical portion 14 side are formed in a spherical shape. The hemispherical portion 14 is nipped between the predetermined number of ribs 28 and the support portion 40 of the support pivot 38 with an urging force of the compression coil spring 44 being acted. Thus, the mirror holder inner 12 is held between the case pivot 18 and the support pivot 38.

When the hemispherical portion 14 is slid with respect to the predetermined number of ribs 28 and the support portion 40, the mirror holder inner 12 is tilted. Consequently, the mirror surface angle of the mirror held by the mirror holder inner 12 is adjusted. The mirror holder inner 12 has a mounting portion for receiving and holding the mirror.

The predetermined number of ribs 28 are formed by thinning the front surface side of the case lower 18A and have the same thickness. For this reason, regardless of the shape of the back surface side of the pivot portion 22 (i.e., a portion opposing the pivot portion 22 on the back surface side of the case lower 18A), a slight formation error such as a dent does not occur due to variation of the thickness of the predetermined number of ribs 28. As a result, a precision of the spherical surface of the pivot portion 22 (the predetermined number of ribs 28) can be ensured. Accordingly, when the hemispherical portion 14 is slid with respect to the predetermined number of ribs 28 and the support portion 40, when the mirror surface angle of the mirror is being adjusted, it is possible to prevent generation of sliding noise between the predetermined number of ribs 28 and the hemispherical portion 14.

Since clearances between the ribs 28 serve as the lubricant pool 30, the lubricant can be sufficiently filled into the pivot portion 22 such that a lack of the lubricant in the pivot portion 22 can be prevented. Accordingly, when the hemispherical portion 14 is slid with respect to the predetermined number of ribs 28 and the support portion 40, when the mirror surface angle of the mirror is being adjusted, it is possible to prevent the hemispherical portion 14 being caught by the predetermined number of ribs 28, swinging or sticking of the mirror.

In the present embodiment, the mirror surface angle adjusting mechanism 10 has motors and the rods 20, and the mirror surface angle of the mirror is automatically adjusted due to the driving of motors. However, the mirror surface angle adjusting mechanism may not include motors and rods, and the mirror surface angle of the mirror may be adjusted manually.

In the present embodiment, the mirror surface angle adjusting mechanism of the present invention is applied to a vehicle door mirror device. However, the mirror surface angle adjusting mechanism of the present invention may be applied to a vehicle fender mirror device.

In accordance with the mirror surface angle adjusting mechanism of the present invention, because the predetermined numbers of ribs have substantially the same thickness, partial dent or concave due to variation of the thickness does not occur such that the precision of the spherical surface of the pivot portion can be ensured. Further, since the clearances between the ribs can serve as the lubricant pool, a lack of the lubricant in the pivot portion can be prevented.

What is claimed is:

1. A mirror surface angle adjusting mechanism comprising:
a mirror retaining member having a hemispherical portion formed in a substantially hemispherical shape;
a case member into which said hemispherical portion of said mirror retaining member is fitted and which has a plurality of ribs arranged in a circumferential direction relative to said hemispherical portion, the ribs including surfaces at a side at which said hemispherical portion fits, being substantially complementary to at least a part of said substantially hemispherical shape; and
a lock means which nips said hemispherical portion of said mirror retaining member between said surfaces of the ribs and the lock means and which presses said hemispherical portion toward the ribs.

2. A mirror surface angle adjusting mechanism according to claim 1, wherein said ribs each have substantially the same thickness as one another.

3. A mirror surface angle adjusting mechanism according to claim 1, wherein said lock means comprises resiliently deformable member for pressing said hemispherical portion of said mirror retaining member.

4. A mirror surface angle adjusting mechanism according to claim 3, wherein said ribs each have substantially the same thickness as one another.

5. A mirror surface angle adjusting mechanism according to claim 1, wherein said ribs are spaced apart from one another forming clearances between said ribs for receiving lubricant and forming lubricant pools.

6. A mirror surface angle adjusting mechanism according to claim 1, wherein said predetermined numbers of ribs are arranged in said circumferential direction at substantially equal angular intervals therebetween.

7. A mirror surface angle adjusting mechanism according to claim 4, wherein said predetermined numbers of ribs are arranged in said circumferential direction at substantially equal angular intervals therebetween.

8. A mirror surface angle adjusting mechanism according to claim 1 further comprising a tilt means for applying a tilt force to said mirror retaining member.

9. A mirror surface angle adjusting mechanism according to claim 4 further comprising a tilt means for applying a tilt force to said mirror retaining member.

10. A mirror surface angle adjusting mechanism according to claim 8, wherein said tilt means comprises a rod member which is slidably provided at said case member and abuts against said mirror retaining member for tilting said mirror retaining member.

11. A mirror surface angle adjusting mechanism according to claim 9, wherein said tilt means comprises a rod member which is slidably provided at said case member and abuts against said mirror retaining member for tilting said mirror retaining member.

12. A mirror surface angle adjusting mechanism according to claim 10, wherein said tilt means comprises a motor which is connected such that said rod member slides due to operation of the motor.

13. A mirror surface angle adjusting mechanism according to claim 11, wherein said tilt means comprises a motor which is connected such that said rod member slides due to operation of the motor.

14. A mirror surface angle adjusting mechanism according to claim 1, wherein said case member is formed of a case lower member having said ribs and a case upper member which is placed upon said case lower member at a side thereof at which said ribs are not provided, and said motor is accommodated between said case lower member and said case upper member.

15. A mirror surface angle adjusting mechanism according to claim 4, wherein said case member is formed of a case lower member having said ribs and a case upper member which is placed upon said case lower member at a side thereof at which said ribs are not provided, and said motor is accommodated between said case lower member and said case upper member.

16. A mirror surface angle adjusting mechanism according to claim 1, wherein said mirror surface angle adjusting mechanism for use with a mirror for rearward vehicle vision, and said mirror retaining member comprises a mounting portion for receiving and holding said mirror.

17. A mirror surface angle adjusting mechanism according to claim 4, wherein said mirror surface angle adjusting mechanism for use with a mirror for rearward vehicle vision, and said mirror retaining member comprises a mounting portion for receiving and holding said mirror.

18. A mirror surface angle adjusting mechanism according to claim 16, wherein the mirror surface angle adjusting mechanism is for use with a vehicle and said mirror surface angle adjusting mechanism is adapted for mounting at least for one of a vehicle fender portion and a vehicle door portion.

19. A mirror surface angle adjusting mechanism according to claim 17, wherein the mirror surface angle adjusting mechanism is for use with a vehicle and said mirror surface angle adjusting mechanism is adapted for mounting at least for one of a vehicle fender portion and a vehicle door portion.
